(19) United States
(12) Patent Application Publication
(10) Pub. No.: US 2003/0137851 A1
(43) Pub. Date: Jul. 24, 2003

(54) Color pre-programmable auxiliary cornering light of a car

(76) Inventor: Chi-Hsiang Pan, Taipei (TW)

Correspondence Address: Chi-Hsiang Pan, PO Box 82-144, TAIPEI, TW

(21) Appl. No.: 10/052,562

(22) Filed: Jan. 23, 2002

(51) Int. Cl. B60Q 1/26

(52) U.S. Cl. 362/540; 362/800; 362/231; 362/276; 362/464

(57) ABSTRACT

A color programmable auxiliary cornering light for a car, comprised of a body containing a control circuit; the control circuit being connected to an array of RGB LED inserted to and connected in parallel with a light holder of an auxiliary cornering light of the car; a setup knob exposed from the body for the auxiliary cornering light to display various colors through change of LED combination pre-programmed by the control circuit when a cornering light of the car is turned on.

### BACKGROUND OF THE INVENTION

1. (a) Field of the Invention

The present invention is related to a color pre-programmable auxiliary cornering light of a car, and more particularly, to one that allows change of color illuminated by the cornering light depends on the weather condition, driver's preference or needs to add fun to the driving.

2. (b) Description of the Prior Art

Usually, cornering lights are provided on both sides of the headlights and the taillights to warn the approaching and following vehicles. However those cornering lights are not visible to vehicles approaching sideways. Therefore, auxiliary cornering lights are provided to latest models to warn vehicles and pedestrians approaching sideways. To achieve that purpose, a bulb is provided in the light holder of said auxiliary cornering light to be illuminated at the same time when the cornering light is turned on. However, the prior art of such auxiliary cornering light is monochromatic thus fails to change its color depending on weather conditions.

### SUMMARY OF THE INVENTION

Therefore, the primary purpose of the present invention is to provide an auxiliary cornering light that can be preset with its color to be displayed depending on the driver's preference and needs to add driving fun and improvement of the general appearance of the car.

To achieve the purpose, a control circuit is provided in the body of the present invention. Said control circuit is connected to an array of RGB LED in red, green and blue. Said array of RGB LED inserted to or adapted to the existing auxiliary cornering light and is connected in parallel with the LH and RH cornering lights. The auxiliary cornering light is turned on to display various colors through the combination of the RGB LED as pre-programmed by the control circuit.

A knob or press button is inserted to and exposed from said auxiliary cornering light and a LED window to be synchronously illuminated with the auxiliary cornering light is provided to the body of the present invention for the driver to turn or push the knob or press button to set the color for display while observing the change of the colors through the LED window.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a schematic view of another preferred embodiment of the present invention;

FIG. 4 is a wiring diagram of the present invention; and

FIG. 5 is a schematic view showing an application of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

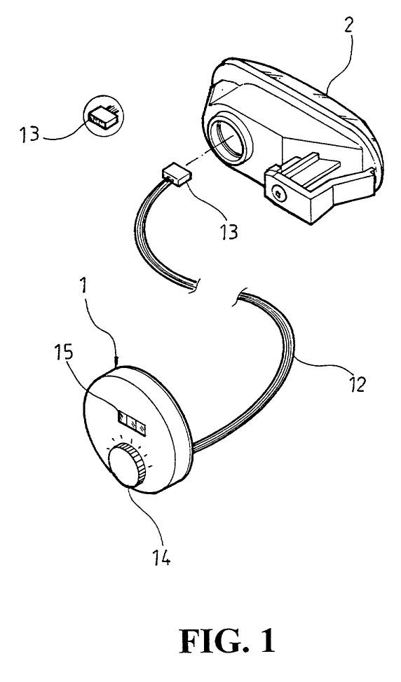

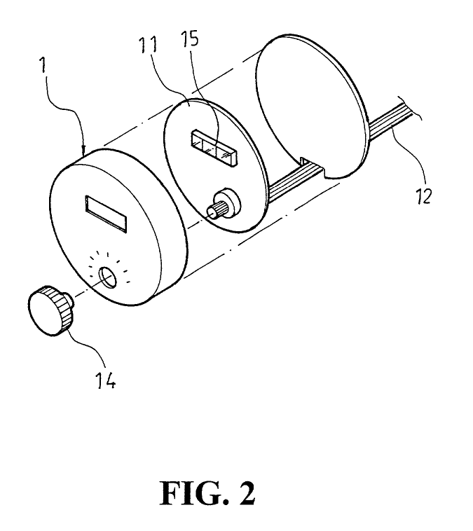

Referring to FIGS. 1 and 2, a preferred embodiment of the present invention is essentially comprised of a body 1 containing a control circuit 11, which is connected by means of a conductor 12 to a RGB LED 13. A knob 14 exposed from the body 1 and an LED window 15 to be synchronously illuminated with the LED 13 are provided to the control circuit 11. By setting up the knob 14, the LED 13 is driven to display in color combination in red, orange, yellow, green . . . etc. as preprogrammed by the control circuit 11.

Said LED 13 is inserted to a light holder 2 of an existing auxiliary cornering light of a car, and connected in parallel with the cornering light of the car for the emission from the LED 13 to the light holder 2 for display of various colors while the driver may observe the color preset through the LED window 15.

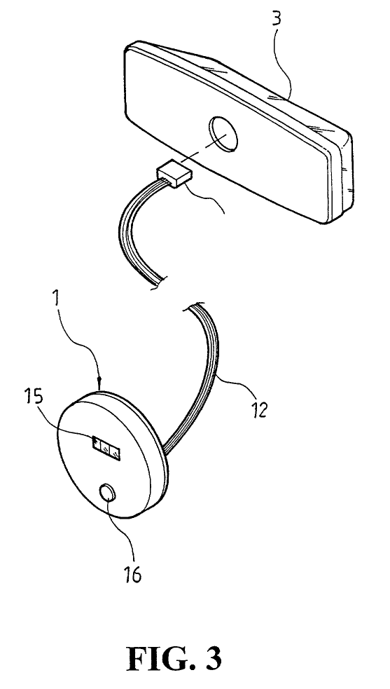

As illustrated in FIG. 3, wherein, the preferred embodiment is applied to a car not provided with the auxiliary cornering light. A hole is drilled through the body of the car to place a flat light holder 3 to receive the insertion of the LED 13. Said flat light holder 3 is fixed to the side of the car by means of a double-faced adhesive tap or otherwise. Similarly, a press button 16 is provided for the control circuit of the body 1 of the present invention to adjust the combination changes of the LED 13.

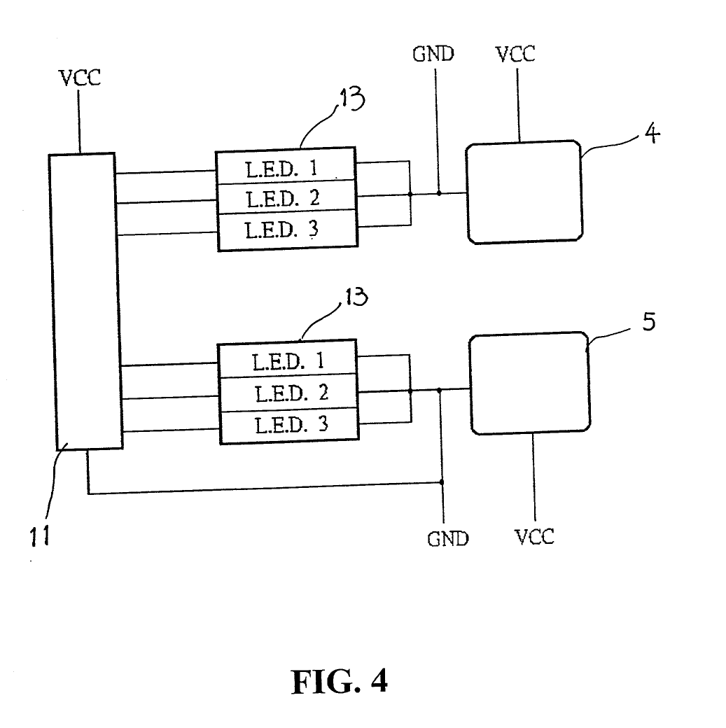

Now referring to FIG. 4, the array of the LED 13 is connected in parallel with both of the LH and RH cornering lights 4 and 5. When the control circuit 1 has completed the setup of the color combination, the LED 13 is illuminated to display change of various colors at the same time when either of the cornering light 4 or 5 is turned on.

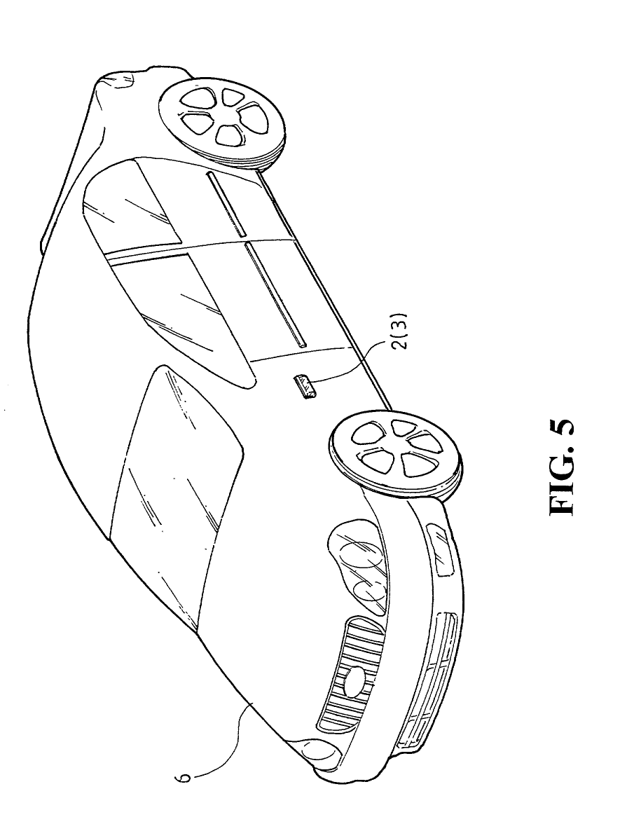

As illustrated in FIG. 5, the preferred embodiment of the present invention is mounted to the side of a car 6 to achieve the purpose as an auxiliary cornering light and to allow the driver to set various colors for display as desired and depending on the weather conditions for adding fun and improving the general appearance of the car 6.

The present invention by LED combination of various colors to add fun to the auxiliary cornering light of the car and improve its general appearance relates to a practical and innovative invention. Therefore, this application for a utility pattern is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A color programmable auxiliary cornering light for a car, comprised of a body containing a control circuit; the control circuit being connected to an array of RGB LED inserted to and connected in parallel with a light holder of an auxiliary cornering light of the car; a setup knob exposed from the body for the auxiliary cornering light to display various colors through change of LED combination pre-programmed by the control circuit when a cornering light of the car is turned on;

2. A color pre-programmable auxiliary cornering light for a car as claimed in claim 1, wherein, an LED window to be synchronously illuminated with the array of the LED is provided to the body of the present invention to facilitate setting of color combination.

3. A color pre-programmable auxiliary cornering light for a car as claimed in claim 1, wherein, a knob or a press button exposed out of the body of the present invention is provided to the control circuit depending on the method of setup.
